(19) United States
(12) Patent Application Publication
(10) Pub. No.: US 2007/0063683 A1
(43) Pub. Date: Mar. 22, 2007

(54) Process and device for recharging portable electronic devices

(75) Inventors: Lionel Coq, Toulouges (FR); Michel Castel, Vezenobres (FR); Cyril Gibergues, Decazeville (FR); Sebastien Grau, Nimes (FR)

Correspondence Address: John S. Egbert;Egbert Law Offices, 7th Floor, 412 Main Street, Houston, TX, 77002, US

(73) Assignee: GALEA TECHNOLOGIES SA, Vezenobres (FR)

(21) Appl. No.: 11/229,145

(22) Filed: Sep. 16, 2005

(51) Int. Cl. G05F 1/00

(52) U.S. Cl. 323/283

(57) ABSTRACT

The recharging device for portable electronic devices includes at least one protective case for a portable electronic device in the process of being recharged, at least one electrical power supply for a battery of a portable electronic device in the case, a case management device capable of controlling on the one hand the power supply for the battery of a portable electronic device placed inside a case and, on the other hand, the access to each case. In production models, at least one protective case includes recharge connectors of different shapes that fit the recharge connectors of portable electronic devices. In production models, the management device includes a user interface which includes a user identification device.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention concerns a process and a device for recharging portable electronic devices. It applies in particular to the recharging of telephones, PDAs and laptops in public locations.

### BACKGROUND OF THE INVENTION

Every user of a cell phone, Personal Digital Assistant (PDA), laptop or notebook has already had the unhappy experience of low or dead batteries in places far from home or the workplace.

Manual recharging systems are known where the user operates a crank for example, to partially recharge the batteries of a cell phone. This type of system is cumbersome, unsuitable for laptops or notebooks, on account of their high power demands and it permits only a very limited recharge (a few minutes of communication) of the cell phone.

The present invention intends to eliminate these drawbacks.

### BRIEF SUMMARY OF THE INVENTION

For this purpose the present invention has in its sight, as a first aspect, a recharging device for portable electronic devices, characterized by the fact that it includes:
at least one protective case for the portable electronic device being recharged,
at least one means of electric supply for a portable electronic device in each said case,
a means of case management adapted for controlling on the one hand the electric supply for the battery of a portable electronic device placed inside a case and, on the other hand, access to each case.

Thanks to these provisions, a user may leave his or her portable electronic device to be recharged under the control of the case management device and in complete security, since the portable electronic device is protected in said case.

In accordance with specific characteristics at least one such protective case includes recharging connections of different forms that are adapted to the recharge connectors of the portable electronic devices.

Thanks to these provisions the connections are protected by the cases and there is no risk of actuating an electrical supply in one case and of opening another case.

In accordance with specific characteristics, the management device includes a user interface which includes a means of user identification.

Thanks to these provisions only the authorized or paying users may have access to the service offered by the recharging device.

In accordance with specific characteristics, the management device is capable of shutting off the electrical supply for a battery of the portable electronic device after a predetermined maximum duration of power supply.

Thanks to these provisions the risk of damaging a battery by overcharging it is limited.

In accordance with specific characteristics, the management device includes a means for selecting a type of battery of a portable electronic device to be recharged.

In accordance with specific characteristics, the management device includes a means of access to recharging characteristics of different types of portable electronic devices.

Thanks to each of these provisions the supplied electrical power is able to rely on the characteristics of the portable electronic device to be recharged.

In accordance with specific characteristics, the management device includes a data base of electrical characteristics of different types of portable electronic devices.

In accordance with specific characteristics, the management device includes a means of communication on a computer network and is adapted for updating the data base with electrical characteristics of batteries for portable electronic devices.

Thanks to each of these provisions the management device is able to select the values of recharge voltages and amperages and possibly to optimize these values during the recharge of the battery of the portable electronic device.

In accordance with specific characteristics, the device such as succinctly shown above includes a means of detecting a voltage decrease at the battery terminals, and the management device is capable of shutting off the power supply when the detection device signals a voltage decrease at the battery terminals.

Thanks to these provisions, when the battery reaches its maximum charge, the recharge is shut off so that the battery does not risk being damaged.

In accordance with specific characteristics, the management device includes a means of reading a memory card storing a password and the management device permits the opening of a case once the user provides the password and after said password has been verified as matching the password stored on the memory card.

Thanks to these provisions the user does not have to memorize any other password besides the one on his memory card, for instance a bank card or a piece of identification.

In accordance with specific characteristics the management device includes a means of permanent transfer to the user of a password and the management device permits the opening of a case once the user has provided said password and it has been verified that said password matches the password that had been transmitted to the user.

Thanks to these provisions the user does not have to memorize the password because a permanent transfer has been made, for example by a short message (known under the name of <<SMS >> for <<short message system>>) or by a ticket with this password printed on it.

The present invention has in its sight, according to a second aspect, a recharging process for portable electronic devices, characterized by the fact that it includes:
a step of opening a protective case for a portable electronic device,
a step of closing said case,
a step of recharging a battery of said portable electronic device,
a step of identification of said user,
a step of opening said case.

Since the advantages, objectives and specific characteristics of this process are similar to those of the device described succinctly above, they are not repeated here.

### BRIEF DESCRIPTION OF THE SEVERAL VIEWS OF THE DRAWINGS

Other advantages, objectives and characteristics of the present invention will become evident from the following description which is meant to be explanatory and in no way limiting, with respect to the attached drawings.

FIG. 1 shows a schematic view of a specific way of producing the device which is the subject of the present invention.

FIG. 2 shows a schematic view of a flow chart of the steps of a specific way of carrying out the process which is the subject of the present invention.

### DETAILED DESCRIPTION OF THE INVENTION

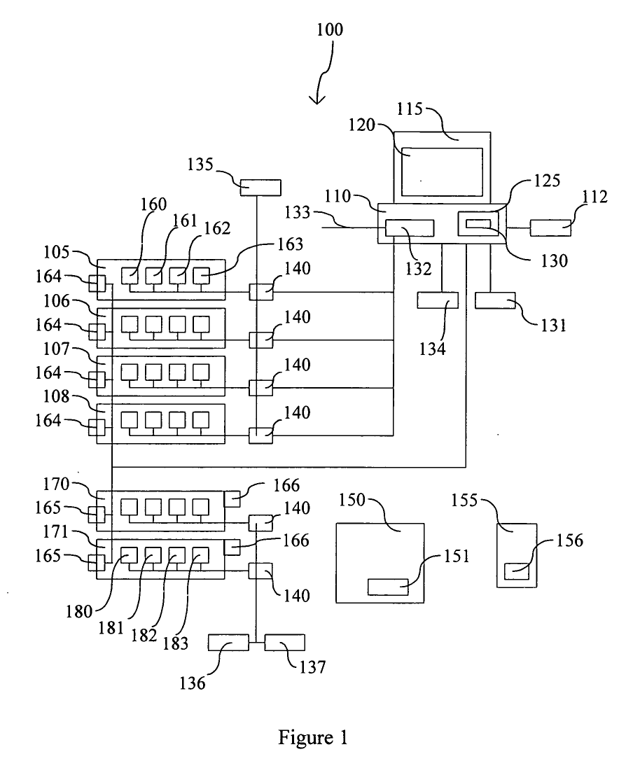

In FIG. 1, one can see portable electronic devices 150 and 155 including batteries 151 and 156 respectively and a recharging device 100 including:
four cases (or “housings”) 105 to 108, each equipped with a locking device 164 and four supply connections 160 to 163, for power connectors of cell phones,
two slides 170 and 171 each equipped with a locking mechanism 165, an automatic opening/closing system 166 and four supply connections 180 to 183 for power plugs of laptop computers,
a computer (industrial PC board) 110 including a ticket printer 112, a display screen 115, a touch screen (or touch matrix) 120, a program memory 125, a data base 130, a modem 132 connected to a computer network 133, a memory card reader 134 and a coin accepting mechanism 131, a serial link (RS 485) for the control of the regulator circuit 140,
one regulator circuit 140 per case and per slide, managed by microcontroller, and
three switching power supplies 135, for cell phones 136 and 137 for laptop computers.

The portable electronic devices 150 and 155 are, for example, laptops, cell phones, pagers, or PDAs. They have connectors for recharging their batteries. The recharge connections 160 to 163 have different forms that are adapted to the recharge connectors of the portable electronic devices.

The recharging device 100 is preferably integrated in a fixture, inside or outside. It is preferably sufficiently water-tight to withstand inclement weather and the kinds of washing operations performed in the locales where it is installed (airports, factory halls, hotel lobbies, on the street . . . ). The recharging device meets the water tightness standard IP65.

The four cases 105 to 108 as well as the two slides 170 and 171, generically called “cases”, contain rigid walls (for example of 1.5 mm thick steel or aluminum) and a door to permit insertion of the portable electronic device to be recharged, access to the connections 160 to 163 and 180 to 183, to plug the portable electronic device into one of these connections, to securely leave the portable electronic device thanks to an electric lock that is controlled by the computer 110. In the production model described and shown here, the cases are different, depending on whether they are intended for cell phones or PDAs, cases 105 to 108, or whether they are intended for laptop computers, slides 170 and 171. The former, for cell phones or PDAs, may be equipped with a base on which the portable electronic devices rest during the recharge. The latter, for computers, take here the form of slides mounted on tracks.

The cases 105 to 108 can be closed by locking devices, for example suction cup magnets of known design.

The supply connections 160 to 163 match up with the different types of connectors that are found on available cell phones.

The slides 170 and 171 are operated for their opening or closing by the automatic opening/closing system 166, of known design, for example by a stepping motor. Each slide is equipped with a locking device 165, for example by suction cup magnets. The supply connections 180 to 183 are adapted to connect to the different power supply connectors on laptop computers on the market. For the sake of conciseness, the slides 170 and 171 are called “cases” in the description.

Preferably, the recharging device 100 includes an autonomous emergency power supply, for example an inverter or a battery capable of supplying power to the device for a period of at least 20 minutes.

Preferably, the cases 105 to 108 and the slides 170 and 171 remain locked in the event of an interruption of the power supply to the recharging device 100.

The computer 110 includes for example an industrial PC board of the known type. The display screen 115, of the known type, for example with a cathode-ray tube or with a flat screen and a touch screen 120 of the known type are placed so that a user may select an image or a text displayed on the screen 115. The screen 115 displays images provided by the computer 110 and the touch screen 120 transmits to the computer 110 a signal that is indicative of the user's finger on the screen. The display screen 115 and the touch screen 120 provide a user interface that is capable, among other things, of identifying each user.

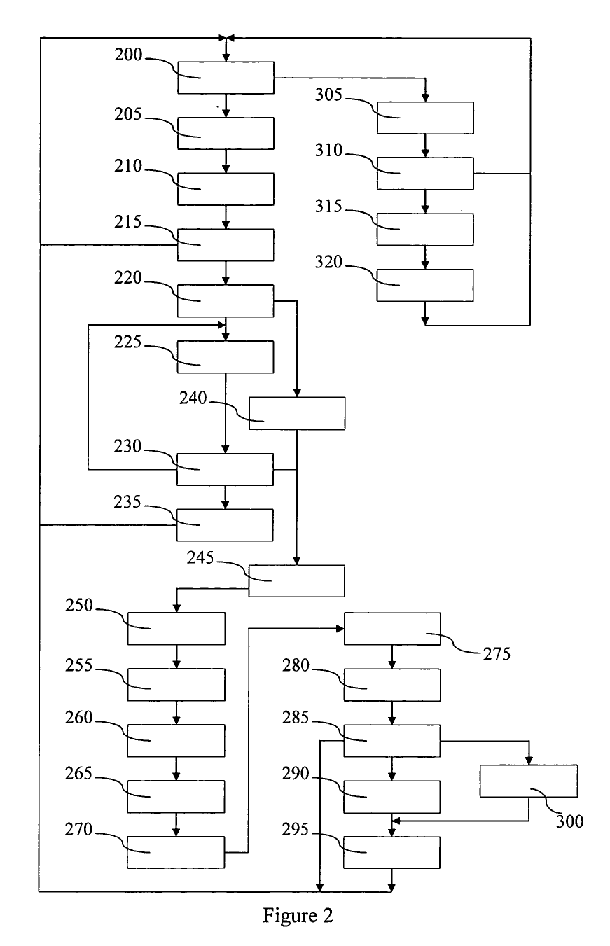

The program memory 125 stores a computer program for the use of the device and of the process which are the subjects of the present invention, for example such as described below with respect to one of the FIG. 1 or 2. Generally speaking, and as shown below, the computer 110 and its peripherals constitute together a means for managing the cases that is capable of controlling on the one hand the power supply for the battery of the portable electronic devices placed inside the cases, and on the other hand, the access to each case (locking devices 164 and 165 and automatic opening/closing systems 166).

The data base 130 includes the electric characteristics of all the batteries used in the laptop computers, PDAs and cell phones. The data base 130 can be updated with the computer 110, following an interrogation of a data base stored on a remote server, for instance over the modem 132 and the computer network 133.

The modem 132 is of the known type, for instance in the domain of Internet access systems. The computer network 133 is of a known type, for example the Internet. The memory card reader 134, of a known type, is capable of reading bank cards, personal IDs, virtual purses. The coin accepting mechanism 131 is of a known type.

The electric power generators 135 and 136 are of a known type, for example linear or switch-mode power supplies. The generator 135 supplies electric power for the connections for laptop computers; and generator 136 supplies electric power for the connections for cell phones. Each generator is controlled by a microcontroller (not shown) connected to the computer 110.

The regulating circuit 140 corresponding to each case is capable of regulating the voltage and amperage of the electric power supplied to the portable electronic device contained in said case, depending on the characteristics of the portable electronic device connected to a power supply connection 160 to 163, in order to optimize its recharging time without damaging its battery.

It is useful to remember that there are different types of batteries defined by their chemical composition. For cell phones and laptop computers the three most common types are Li-ion, Ni-MH and Ni—CH. Each type of battery corresponds to a different charge/discharge curve, as well as to battery-specific characteristics (maximum accepted voltage and current, temperature and pressure, useful life . . . ). Each battery can be classified according to three classes: the chemical type, the average usage voltage (in V), and the capacitance (in Ampere-hours). The batteries can however be recharged up to five times their capacitance without deterioration over a limited time.

The computer 110 identifies in real time the portable electronic device which is hooked up in each case, either through the user interface (display screen 115 and touch screen 120) or through communication (not shown) with the battery, in case it is of the “smart battery” type (battery capable of identifying itself) used in certain portable electronic devices. The computer 110 analyzes the data base 130 so as to determine the characteristics of the battery of this particular portable electronic device, and adjusts the recharging parameters (voltage and current) depending on these characteristics. The recharge parameters are transmitted to the regulating circuit 140 which then controls at all times the condition of the battery and shuts off the recharge when the required values have been reached.

As a security measure the recharge is made at three times the capacitance of the battery which permits reducing the recharge time to approximately twenty minutes.

The voltage at the terminals of the regulating circuit 140 and of the battery to which it is connected, evolve during a recharging process, in the following manner: when the battery is discharged, the voltage is lower than the nominal voltage of the battery, then it increases progressively until it reaches a maximum voltage (when the battery is properly recharged) that is above the nominal voltage of the battery before decreasing. For an optimal and safe recharge, the computer 110 is able to receive, from the regulating circuit 140, the voltage at the terminals of the battery and when a decrease of voltage is detected, to shut off the electric power supply to the battery. Furthermore, even if no voltage decrease is detected at the battery terminals, the computer 110 shuts off the power supply to the battery at the end of a predetermined maximum recharge period, for example 20 minutes.

In one variant (not shown) the power supply to the battery is provided by a solar panel or by induction.

The user interface functions as follows: To make a selection, the user places his finger on the part of the display screen 115 which displays the desired selection. The touch screen 120 detects this position and transmits it to the computer 110.

Following an interval of predetermined duration (one minute for example), when no action is carried out, a standby screen representing the recharge levels of the electronic devices present in each case or slide, is displayed. The first chosen screen is displayed when any action is performed on the touch screen.

As soon as a user touches the screen, the user selects on a first screen one of the options “recharge computer”, “recharge telephone” or “retrieve device”.

Once the user has selected one of the recharge options, a second screen requests the trademark (brand) of his or her portable electronic device and displays a list of brands from which the user can select. Once this selection has been made a third screen asks the user to indicate the model of his electronic device and features a list of models for the brand selected on the second screen.

When the model has been selected by the user, the computer 110 selects an empty case and indicates its number to the user, while the electric lock on this case is being opened. The user can then place his or her electronic device in this case and connect it to the power supply connector that is appropriate for his or her electronic device.

Once the connection has been detected, a fourth screen asks the user which payment method he or she wants to use, cash or bank card. Once the user has selected the payment method, a fifth screen invites him or her to pay the appropriate amount for the recharge, 1 euro or one dollar for example.

Before or after payment has been made by means of the memory card reader (with entry of a password stored by the bankcard) 134 or the coin accepting mechanism 131 in the traditional way, a sixth screen indicates to the user the password which will be required to withdraw the portable electronic device. Depending on the options:
a password, chosen by the user, is entered by the user on a screen dedicated to actuating the locking (and, with respect to the slides 170 and 171, the closing) of access to the content of the case concerned by the corresponding locking device,
if the user has paid with a subscription card, a virtual purse card, or any other memory card, this password is the password of the card concerned,
if the user recharges a computer and provides his or her cell phone number, a password is automatically transmitted via the modem, the computer network and a SMS message on the user's cell phone,
a password is printed out by the printer 112 on a ticket which is issued to the user.

In the last two cases, the computer includes a permanent means of transfer of the password to the user, by way of the cell phone's memory or the ticket issued to the user, and preferably before closure of the case and before payment, the user is asked whether he or she has properly received the password.

Finally, the case is closed immediately by the corresponding locking device.

As a variant, the computer determines the charge level of the battery of the portable electronic device, estimates the recharging time and indicates this to the user.

If, on the first screen, the user selects the option “restitution of the device”, the user is requested, on a seventh screen to enter the password and, preferably, the number of the case in which his portable electronic device is located. If the user has provided his telephone number and has forgotten the password, this telephone number serves as the substitute password to recover his portable electronic device. Following verification of the password, the lock of the case corresponding to the portable electronic device of the user is unlocked by the corresponding locking device (and, with respect to the slides 170 and 171, the opening) actuated by the computer 110 and an eighth screen invites the user to remove the portable electronic device from the case in question.

As a variant, the password is replaced by some confidential information which only the user is supposed to know, for example his or her last and first name, address, the first digits of his or her Social Security Number, . . . . This information is requested before payment, [and] then at the time of withdrawal of the portable electronic device, before the case door is unlocked.

According to variants not shown, the recharging device includes a means of connection between the portable computer system and the computer network 133, by wired or wireless (WIFI for instance) connection without the user being necessarily required to insert his laptop or notebook into one of the cases.

Preferably the computer 110 is equipped with protective means against attacks that could come from the computer network 133, for instance a firewall, proxy, anti-virus appliance, electronic address filter (“URL” (for “uniform resource locator”), . . .

FIG. 2 shows a step 200 during which the first screen (welcome menu) is displayed until the user chooses either to request a recharge of his portable electronic device in which case step 205 is to be performed, or to remove a portable electronic device in which case step 305 is to be performed.

During step 205, the user selects the brand and model of his or her portable electronic device. During step 210 the availability of a case capable of accepting the portable electronic device is verified; if none is available, a screen is displayed asking the user to wait until a case becomes available, step 215 and one returns to step 200. If a case is available while in step 220, the user is asked to select a method of payment. If payment by memory card is selected during step 225, the user inserts a bankcard into the memory card reader 134 and enters his or her password (known under the name of PIN for “personal identification number”). During a step 230, the password stored on the bankcard is read and verified. If the password entered by the user is incorrect, there is a return to step 225, except three incorrect passwords have been entered successively, in which case there is a return to step 200 after release of the bankcard, step 235. If the password is correct or if the user has selected the cash method of payment and has inserted the required amount into the coin accepting mechanism, step 240, [then] during step 245 the number of the case is indicated to the user and the case in question is opened (unlocking of the door and, if applicable, opening of the door by an electric motor which is not shown).

Then during step 250, it is necessary for the user to hook up his or her portable electronic device to one of the connectors of the case in question and to close again the door of this case. The closing of the case is detected during step 255. Then, during step 260, a password is determined as indicated with respect to FIG. 1 and, if applicable, receipt of the password by the user is verified. The password is then stored in the memory, step 265, preferably into a permanent memory which will not be erased in case of a power failure, for instance a hard disk, and the opening of the case is locked, step 270. Then the condition of the battery is determined, step 275, based on its electric characteristics, the recharging time is estimated, based on the charge status of the battery, and the electric characteristics of the battery stored in the data base, step 280, and the recharge of the portable electronic device is started, step 285, in a regulated manner as indicated above, [and] a delay of predetermined duration starts, for example 20 minutes, which is assigned to the case in question and there is a return to step 200, while step 290 is being performed.

During step 290, the voltage at the battery terminals is checked to see if it decreases. If that is the case, during step 295, the recharge of the battery is cut off and there is a return to step 200.

When a dwell time is complete, step 300, recharging of the battery is cut off, step 295, and one returns to step 200.

During step 305 the user is asked to indicate the password determined during step 260, and if applicable, the number of the case containing his or her portable electronic device. The user enters his or her password during step 310. After three entries of invalid passwords the user is returned to step 200. If the password entered is correct, during step 315, the recharge in the case in question is shut off, and during step 320, the case in question is unlocked and it is either opened or its opening by the user is authorized. Then there is a return to step 200.

We claim:

1. Recharging device for portable electronic devices comprising:
at least one protective case for portable electronic devices being recharged,
at least one electrical power supply for a battery of a portable electronic device in each case, and
a case management device means controlling not only access to each case but also the power supply for the battery of a portable electronic device that has been placed inside a case, by supplying a capacitance greater than the capacitance of the battery, with the management device maintaining at least a predetermined maximum duration of power supply and being capable of shutting off the power supply to each battery of a portable electronic device after a predetermined maximum duration of power supply.

2. Device according to claim 1, wherein the management device comprises a data base of electrical characteristics of different types of portable electronic devices.

3. Device according to claim 2, wherein the management device comprises a means of communication on a computer network, updating the data base of electrical characteristics of batteries for portable electronic devices.

4. Device according to claim 1, further comprising:
a detection device for decreased voltage at the terminals of the battery and that the management device is capable of actuating the shutoff of electrical power when the detection device signals a decrease of the voltage at the battery terminals.

5. Device according to claim 1, wherein the management device comprises a memory card reader storing a password and the management device actuating the opening of a case after the user provides said password and after verification that said password matches the password stored by the memory card.

6. Device according to claim 1, wherein the management device comprises a means of permanent transfer of a password to the user and the management device allows a case to open when the user provides said password and after verification that said password matches the password transmitted to the user.

7. Process of recharging portable electronic devices comprising the steps of:
opening a protective case for portable electronic devices,
closing said case,
recharging a battery of said portable electronic device by supplying a capacitance greater than the capacitance of the battery, during which the power supply to each battery of portable electronic devices is shut off after a predetermined maximum duration of power supply that is stored in memory,
identifying said user, and
opening said case once the user has been identified.
